(19) United States
(12) Patent Application Publication
(10) Pub. No.: US 2026/0128853 A1
(43) Pub. Date: May 7, 2026

(54) METHODS AND SYSTEMS FOR ADJUSTING DIFFERENTIAL CLOCK SIGNALS

(71) Applicant: Celestial AI Inc., Santa Clara, CA (US)

(72) Inventors: Hemesh Yasotharan, Toronto (CA); Parmanand Mishra, Cupertino, CA (US)

(73) Assignee: Celestial AI Inc., Santa Clara, CA (US)

(21) Appl. No.: 18/934,986

(22) Filed: Nov. 1, 2024

(51) Int. Cl. H04L 7/00

(52) U.S. Cl. CPC H04L 7/0016

(57) ABSTRACT

The present invention is directed to electrical circuits. In an embodiment, the present invention provides a clock compensation device configured to correct timing discrepancies in differential clock signals. The circuit comprises positive and negative lines with multiple inverters, including crossover inverters that generate correction signals to maintain synchronization between the clock signals. There are other embodiments as well.

### FIELD OF INVENTION

The present invention is directed to electrical circuits.

### BACKGROUND OF THE INVENTION

In high-speed communication systems and other digital applications, the integrity and timing of clock signals are crucial for ensuring accurate data transmission and processing. Clock signals serve as the timing reference that coordinates the sequence of operations within electronic circuits, such as data sampling, processing, and transmission. In many modern systems, data is transmitted as differential signals, where a pair of clock signals—one positive and one negative—are used to reduce noise and improve signal integrity. However, in practical implementations, clock signals are often subject to various forms of degradation as they propagate through the circuit, such as phase misalignment, inter-symbol interference, jitter, and others.

To address these issues, circuits often incorporate clock signal correction mechanisms. These mechanisms adjust the timing and phase of the clock signals in real time, ensuring that the differential signals remain synchronized and that the overall system performance is maintained. By correcting phase misalignments, duty cycle distortions, and other forms of degradation, clock signal correction improves the reliability and accuracy of high-speed communication systems.

In the past, various mechanisms for clock signal corrections have been proposed, but they are inadequate. Improved methods and systems are desired.

### BRIEF DESCRIPTION OF THE DRAWINGS

FIG. 1 is a simplified diagram illustrating circuit 100 for adjusting differential clock signals according to embodiments of the present invention.

FIG. 2 is a simplified plot illustrating pre-cursor and post-cursor correction according to embodiments of the present invention.

FIG. 3 is a simplified diagram illustrating circuit 300 for providing adjusting differential clock signals according to embodiments of the present invention.

FIG. 4 is a simplified diagram illustrating driver circuit 400 with clock signal correction according to embodiments of the present invention.

FIG. 5 is a simplified diagram illustrating an electro-photonic network with clock signal correction according to embodiments of the present invention.

### DETAILED DESCRIPTION OF THE INVENTION

The present invention is directed to electrical circuits. In an embodiment, the present invention provides a clock compensation device configured to correct timing discrepancies in differential clock signals. The circuit comprises positive and negative lines with multiple inverters, including crossover inverters that generate correction signals to maintain synchronization between the clock signals. There are other embodiments as well.

The following description is presented to enable one of ordinary skill in the art to make and use the invention and to incorporate it in the context of particular applications. Various modifications, as well as a variety of uses in different applications will be readily apparent to those skilled in the art, and the general principles defined herein may be applied to a wide range of embodiments. Thus, the present invention is not intended to be limited to the embodiments presented, but is to be accorded the widest scope consistent with the principles and novel features disclosed herein.

In the following detailed description, numerous specific details are set forth in order to provide a more thorough understanding of the present invention. However, it will be apparent to one skilled in the art that the present invention may be practiced without necessarily being limited to these specific details. In other instances, well-known structures and devices are shown in block diagram form, rather than in detail, in order to avoid obscuring the present invention.

The reader's attention is directed to all papers and documents which are filed concurrently with this specification and which are open to public inspection with this specification, and the contents of all such papers and documents are incorporated herein by reference. All the features disclosed in this specification, (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Furthermore, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of” or “act of” in the Claims herein is not intended to invoke the provisions of 35 U.S.C. 112, Paragraph 6.

When an element is referred to herein as being “connected” or “coupled” to another element, it is to be understood that the elements can be directly connected to the other element, or have intervening elements present between the elements. In contrast, when an element is referred to as being “directly connected” or “directly coupled” to another element, it should be understood that no intervening elements are present in the “direct” connection between the elements. However, the existence of a direct connection does not exclude other connections, in which intervening elements may be present.

Moreover, the terms left, right, front, back, top, bottom, forward, reverse, clockwise and counterclockwise are used for purposes of explanation only and are not limited to any fixed direction or orientation. Rather, they are used merely to indicate relative locations and/or directions between various parts of an object and/or components.

Furthermore, the methods and processes described herein may be described in a particular order for ease of description. However, it should be understood that, unless the context dictates otherwise, intervening processes may take place before and/or after any portion of the described process, and further various procedures may be reordered, added, and/or omitted in accordance with various embodiments.

Unless otherwise indicated, all numbers used herein to express quantities, dimensions, and so forth should be understood as being modified in all instances by the term “about.” In this application, the use of the singular includes the plural unless specifically stated otherwise, and use of the terms “and” and “or” means “and/or” unless otherwise indicated. Moreover, the use of the terms “including” and “having,” as well as other forms, such as “includes,” “included,” “has,” “have,” and “had,” should be considered non-exclusive. Also, terms such as “element” or “component” encompass both elements and components comprising one unit and elements and components that comprise more than one unit, unless specifically stated otherwise.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items. By way of example, the phrases “at least one of A, B, and C” or “at least one of A, B, or C” each refer to only A, only B, or only C; and/or any combination of A, B, and C. In instances where it is intended that a selection be of “at least one of each of A, B, and C,” or alternatively, “at least one of A, at least one of B, and at least one of C,” it is expressly described as such.

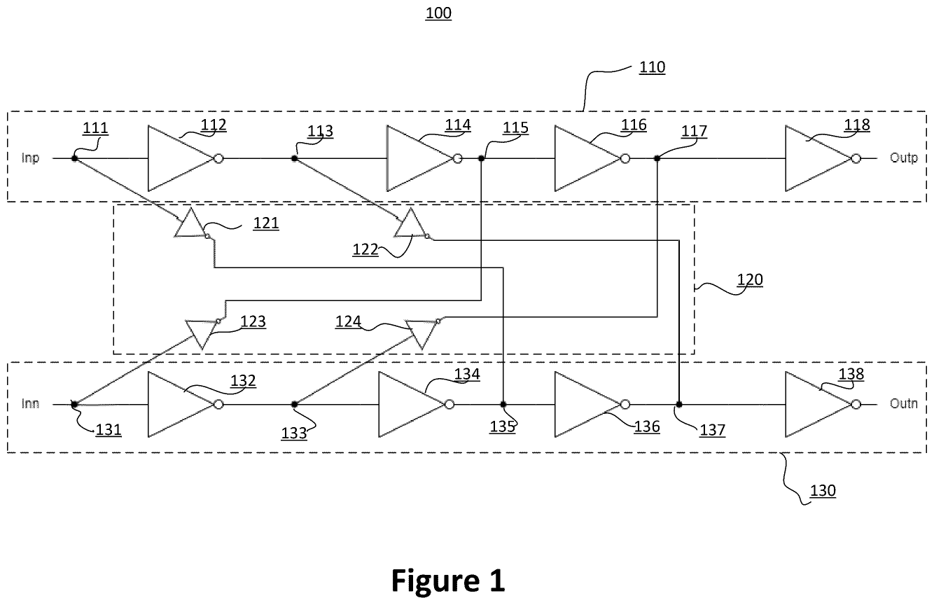

FIG. 1 is a simplified diagram illustrating circuit 100 for adjusting differential clock signals according to embodiments of the present invention. This diagram is merely an example, which should not unduly limit the scope of the claims. One of ordinary skill in the art would recognize many variations, alternatives, and modifications.

As an example, circuit 100 comprises three sections: the positive line 110, the crossover section 120, and the negative line 130. The positive line 110 begins at the positive input (Inp) and extends to the positive output (Outp). This line is responsible for processing the positive clock signal, which is part of the differential clock signal pair received by the circuit. The positive line includes a series of inverters, specifically a first positive inverter and a second positive inverter. Each inverter on the positive line introduces a specific, known delay to the positive clock signal as it propagates from the input to the output. Depending on the implementation, the number of inverters on the positive line varies. For example, the term “inverter” refers to a logic gate that flips the input signal's logic level. In other words, if the input is a logical “1” (high), the output will be a logical “0” (low), and vice versa. In the context of this circuit, each inverter not only flips the signal but also introduces a slight propagation delay. This delay is due to the time it takes for the signal to travel through the inverter's internal circuitry.

Each of these inverters is characterized by a delay, often measured in picoseconds (ps). The total delay introduced by the series of inverters in the positive line can be adjusted by varying the number of inverters, the specific design of each inverter, and the spacing between them. The delay introduced by each inverter is helpful in signal adjustment and correction, as it allows the circuit to time the processing of the negative clock signal in the negative line. The delayed positive signal serves as a reference for adjusting the negative clock signal at the corresponding node on the negative line. By accurately controlling the delay through these inverters, the circuit can ensure that the positive and negative clock signals remain synchronized, even as they undergo various corrections.

As the positive clock signal propagates through the positive line, it passes through multiple inverters. Each inverter adds a fixed delay to the signal, which is critical for timing adjustments across the circuit. For example, inverter 111 introduces the first delay and inversion to the positive clock signal immediately after it enters the circuit. As the signal continues, Inverter 113 introduces a second delay and further inverts the signal. This pattern continues with Inverters 115 and 117, each adding its own delay and inversion, progressively shaping the timing and phase of the positive clock signal as it approaches the output (Outp).

The nodes where these inverters are connected play a significant role in the timing and characteristics of the correction signals introduced by the crossover section. Node 113, for example, is positioned after the first delay from inverter 111 and before the second delay from inverter 113. This node provides a clock signal that has experienced one delay and one inversion. Node 117 represents a more delayed and further inverted version of the positive clock signal. The choice of which node to use for coupling in the crossover section directly impacts the effectiveness and timing of the corrections applied.

The negative line 130 runs parallel to the positive line, starting at the negative input (Inn) and ending at the negative output (Outn). This line handles the negative clock signal, which is the counterpart to the positive clock signal in the differential pair. Like the positive line, the negative line includes a first negative inverter and a second negative inverter. These inverters also introduce specific delays into the negative clock signal, similar to the delay characteristics found in the positive line. Like positive line 110, the negative line includes a series of inverters—131, 133, 135, 137—each introducing specific delays and signal inversions. Inverter 131 provides the first delay and inversion, beginning the process of timing the negative clock signal. As the signal propagates, inverter 133 introduces a second delay and inversion. Inverters 135 and 137 continue this process, each adding their own delays and inversions. The nodes along the negative line help determine where the crossover inverters will introduce correction signals. For example, node 133 is positioned after the first delay from inverter 131 and before the second delay from inverter 133. A crossover inverter injecting a signal at this node would be correcting a signal that has been delayed and inverted once. Node 137 is positioned after several delays and inversions. The timing and characteristics of the signal at this node would be different from those at earlier nodes.

The adjustment or correction between the positive and negative clock signals is achieved by using the delayed positive signal as a timing reference. In various implementations circuit 100 adjusts the negative clock signal at specific nodes along the negative line based on the known delays introduced by the inverters on the positive line. This adjustment ensures that the timing of the negative clock signal is precisely controlled to match the positive clock signal, thereby minimizing timing errors and ensuring signal integrity.

The crossover section 120 is configured to correct distortions that can occur in differential clock signals, such as differential duty cycle distortion and pre-cursor inter-symbol interference (ISI). As an example, inverter 121 generates a correctional signal by taking the positive clock signal from node 111 on the positive line, which is an un-delayed and un-inverted signal directly from the positive input (Inp). Inverter 121 inverts this signal, flipping its logical state (i.e., changing a logical “1” to a “0” and vice versa), and introduces a delay. This correctional signal is then injected into node 135 on the negative line, where it corrects the negative clock signal. The delay introduced by Inverter 121 comprises a propagation delay caused by the internal circuitry of the inverter. This delay is used to align the correctional signal with the negative clock signal at node 135. The negative clock signal at node 135 is delayed (relative to the negative input clock signal at node 131) twice by inverters 132 and 134 on negative line 130, and has undergone two signal inversions.

Inverter 122 is connected to node 113 on positive line 110, which provides a positive clock signal that has been delayed by inverter 112. Inverter 122 further inverts this signal and introduces an additional delay. This correctional signal is injected at node 137 on the negative line 130. The delay introduced by Inverter 122 is the result of both the delay in the positive line (from inverter 112) and the delay of crossover inverter 122.

Inverter 123 operates similarly to Inverter 121, but it takes its input from node 131 on negative line 130. Inverter 123 inverts the negative input clock signal (Inn at node 131) and introduces its delay, creating a correctional signal that is applied to node 115 on the positive line. By timing the correctional signal to align with the positive clock signal at node 115, inverter 123 helps provide a correction.

Inverter 124 is connected to node 133 on the negative line, which provides a negative clock signal that has been delayed once by Inverter 132. Inverter 124 further inverts this signal and introduces an additional delay before applying it as a correctional signal to node 117 on the positive line 110. The delay introduced by Inverter 124 is cumulative, including the delays from Inverters 132 and 133 on the negative line, as well as its own internal delay.

The crossover inverters 121, 122, 123, and 124 are useful for maintaining the integrity of the differential clock signals as they traverse the circuit. Depending on the implementation, connections of crossover inverters may be configured. For example, if a bigger correction (e.g., bigger timing window) is needed, the output of inverter 121 may be provided at node 137 or even at the negative output node Outn.

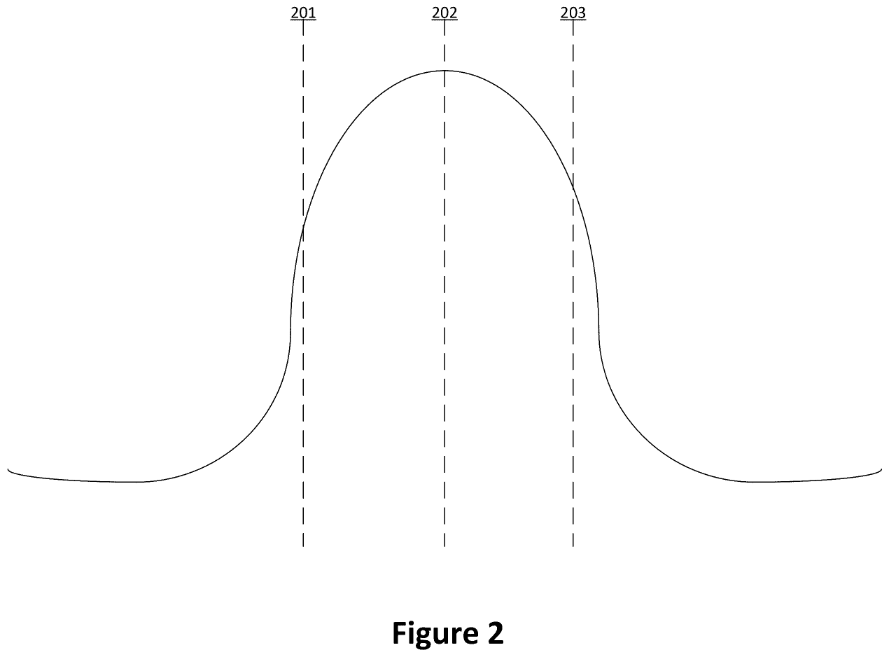

FIG. 2 is a simplified plot illustrating pre-cursor and post-cursor correction according to embodiments of the present invention. This diagram is merely an example, which should not unduly limit the scope of the claims. One of ordinary skill in the art would recognize many variations, alternatives, and modifications. Pre-cursor ISI occurs (e.g., at 201) when the tail of the previous pulse interferes with the leading edge of the current pulse. This type of interference can be corrected by introducing feed-forward paths that leverage delayed signals from crossover inverters. For example, crossover inverters such as 121, 122, 123, and 124 generate correction signals based on delayed and inverted versions of the differential clock signals. By injecting these signals into specific nodes along the positive and negative lines, the circuit can adjust the timing of the current pulse to counteract the effects of pre-cursor ISI. For example, a delayed signal from Inverter 121 can be injected at node 137 to correct the timing of the negative clock signal. This correction compensates for the spread of the pulse, reducing the interference from the previous pulse and sharpening the rise time of the current pulse.

Post-cursor ISI occurs (e.g., at 203) when the current pulse interferes with subsequent pulses. This interference can be mitigated by introducing feedback paths from the output buffer to an earlier stage in the signal processing chain. For example, a feedback switch might be added from the output buffer to the Nth input buffer to correct for post-cursor ISI. The feedback loop allows the circuit to dynamically adjust the timing and shape of the signal based on the actual output, thereby reducing the impact of post-cursor ISI.

Now referring back to FIG. 1. Depending on the implementation, crossover section 120 may be reconfigured. In some embodiments, crossover section 120 comprises a matrix bus that is capable of reconfiguring connections of crossover converters (e.g., moving input of inverter 121 to node 117, or moving output of inverter 123 to node 117, etc), allowing them to be connected to different nodes along the positive and negative lines. For example, the configuration of crossover inverter connections may be controlled by a controller that is configured on a feedback path, using differential outputs from terminals Outp and Outn.

For example, inverter 121, by default is connected to node 111 on the positive line and provides a correction signal to node 135 on the negative line. If needed, the output of inverter 121 can be re-routed to node 137. This would apply the correction signal to a more delayed and inverted version of the negative clock signal, allowing for finer control over the signal's timing as it approaches the output. Similarly, inverter 121 could be configured to provide its correction signal directly to the negative output node (Outn). This would be useful in scenarios where the most significant corrections are needed at the very end of the signal path, ensuring that the final output signal is precisely aligned with the corresponding signal on the positive line.

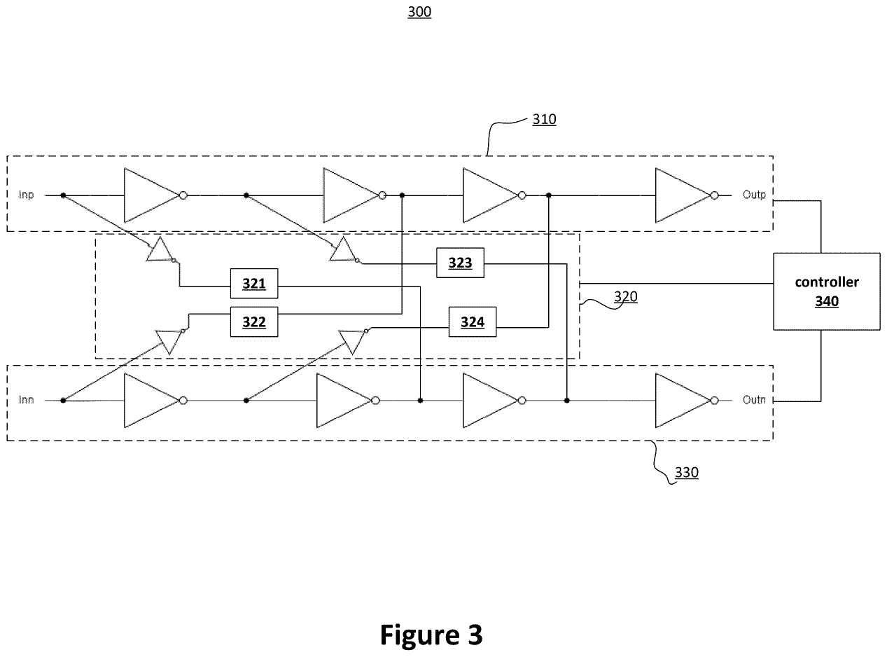

FIG. 3 is a simplified diagram illustrating circuit 300 for providing adjusting differential clock signals according to embodiments of the present invention. This diagram is merely an example, which should not unduly limit the scope of the claims. One of ordinary skill in the art would recognize many variations, alternatives, and modifications.

Circuit 300 comprises positive line 310 for processing the positive differential clock signal, which is received at the input (Inp) and transmitted to the positive output (Outp). The positive line includes a series of inverters that propagate and delay the positive clock signal, ensuring it is properly timed and conditioned as it moves through the circuit. Negative line 330 operates in parallel with the positive line, handling the negative differential clock signal. This signal enters the circuit at the negative input (Inn) and exits at the negative output (Outn). Like the positive line, the negative line also includes inverters that introduce delays to the negative clock signal, ensuring it remains synchronized with the positive clock signal.

Corrections for clock signals are applied at crossover section 320, which is responsible for introducing correction signals to maintain the integrity and synchronization of the differential clock signals. This section comprises crossover inverters that can be selectively connected to different nodes on the positive and negative lines. Cross-over section 320 comprises switches 321-324, which are configured within the crossover section and are controlled by a controller 340. For example, the switches determine which crossover inverters are activated and where the correction signals are applied. For instance, a switch might connect a crossover inverter to a specific node on the negative line to correct timing discrepancies between the positive and negative signals.

Controller 340 plays an important role in the operation of the circuit. It generates control signals based on the outputs (Outp and Outn) of the positive and negative lines. By analyzing these outputs, the controller determines if any timing corrections are necessary and adjusts the switches (321-324) accordingly. In various embodiments, the control signals generated by controller 340 direct the switches to select the appropriate crossover inverters within the crossover section. As explained above, crossover section 340 may include a matrix of switches to control the selection and connection of crossover inverters.

In operation, circuit 300 receives differential clock signals at the inputs (Inp and Inn) and processes them through positive and negative lines 310 and 330. As these signals propagate, the inverters on each line introduce delays, which provide synchronization between the positive and negative clock signals. Crossover section 320 then applies correction signals to either or both lines, depending on the timing discrepancies detected by controller 340. By adjusting the position and activation of the crossover inverters via switches 321-324, the circuit can fine-tune the timing of the differential signals. This correction is essential for ensuring that the outputs (Outp and Outn) are properly aligned, even under varying signal conditions.

In some embodiments, crossover section 320 includes a large number of crossover inverters that are interconnected by a bus matrix, which allows for flexible and precise fine-tuning inverter selection via selective activation. For example, the bus matrix configuration provides the ability to select multiple crossover inverters simultaneously or in sequence, depending on the specific timing and phase correction needs.

In some embodiments, controller 340 is configured to execute an algorithm to dynamically adjust the selection of crossover inverters in a feedback path. For example, controller 340 dynamically adjust the selection of crossover inverters based on real-time feedback from the circuit outputs (Outp and Outn). Controller 340 continually monitors these outputs to detect timing discrepancies or distortions in the differential clock signals. In response to these discrepancies, controller 340 generates control signals that adjust the switches 321-324 to select the appropriate crossover inverters. This dynamic selection process ensures that the correction signals are applied precisely where and when they are needed, helping to maintain synchronization between the positive and negative clock signals.

In certain embodiments, controller 340 may be configured to execute an algorithm that determines the optimal crossover inverter selection based on various factors, such as the nature of the timing discrepancies, the operational conditions of the circuit, and historical performance data. In a specific implementation, an algorithm is configured to optimize the timing corrections by selecting crossover inverters that provide the most effective phase and timing adjustments. This might involve adjusting the timing of the correction signals, selecting specific nodes for signal injection, or even activating multiple crossover inverters to provide compound corrections.

In some implementations, controller 340 may utilize a lookup table to streamline the selection process. For example, the lookup table comprises pre-determined settings for crossover inverter selection based on various operational scenarios. For example, the lookup table might specify which crossover inverters should be activated when certain types of timing errors are detected. The controller can quickly reference this table to make decisions, reducing the computational load and speeding up the response time for applying corrections.

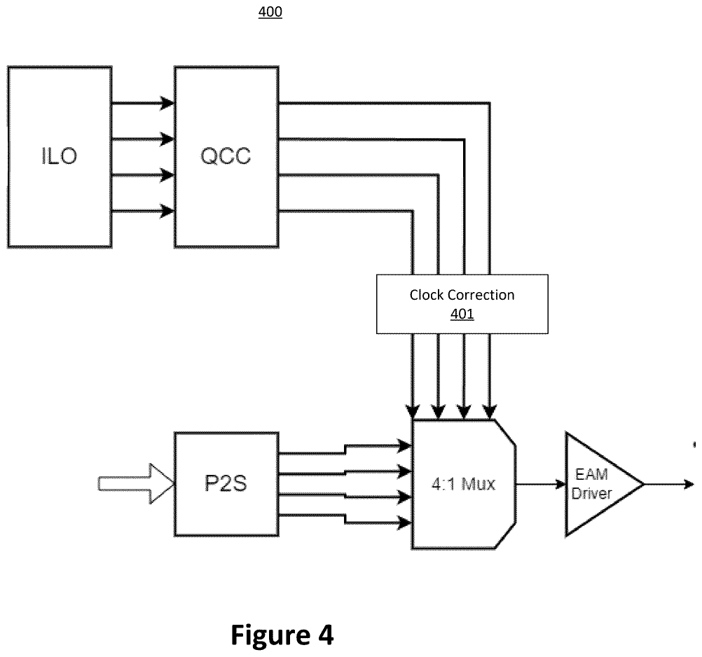

FIG. 4 is a simplified diagram illustrating a driver circuit 400 with clock signal correction according to embodiments of the present invention. This diagram is merely an example, which should not unduly limit the scope of the claims. One of ordinary skill in the art would recognize many variations, alternatives, and modifications. As an example, driver circuit 400 where circuit 300 (or circuit 100) provides corrections to the clock signals that feed into a 4:1 multiplexer (MUX). For example, circuit 300 helps the differential clock signals driving the MUX to be correctly synchronized and conditioned. As shown, driver circuit 400 includes an injection-locked oscillator (ILO), a quadrature clock conditioner (QCC), a parallel-to-serial (P2S) converter, a 4:1 MUX, and an electro-absorption modulator (EAM) driver.

In an embodiment, the ILO is configured for generating a stable reference clock signal, which clock signal is typically clean and has low jitter, making it suitable as a timing reference for high-speed operations. The output of the ILO is provided to the next stage, the QCC. The QCC processes the reference clock signal generated by the ILO and outputs multiple clock phases. These clock phases, for example, are used for the timing of data transitions in the. In an embodiment, the QCC outputs four distinct clock signals, each representing a different phase of the clock cycle. These phase-shifted clock signals are then provided to the 4:1 MUX.

The P2S converter receives parallel data inputs and converts them into serial data streams. The serialized data streams from the P2S are then fed into the 4:1 MUX for further processing. The 4:1 MUX is configured for multiplexing the four input data streams from the P2S into a single high-speed data stream. The timing of this multiplexing operation is controlled by the clock signals provided by the QCC. It is to be appreciated that accurate clock signals are important for the correct operation of the MUX, as they determine when each of the four input data streams is selected and transmitted as part of the output serial data stream. The EAM Driver amplifies the output of the 4:1 MUX and prepares it for transmission, typically in an optical communication system.

Circuit 300 (or e.g., circuit 100 in FIG. 1) in FIG. 3, in various embodiments, ensures that the clock signals feeding into the 4:1 MUX are synchronized and free from distortions. As an example, circuit 300 is configured as clock correction circuit 401 in FIG. 4. In various embodiments, ILO generates a stable reference clock signal, which is then processed by the QCC. The QCC outputs multiple phase-shifted clock signals that are delivered to the clock correction circuit 401. Cclock correction circuit 401 receives the differential clock signals from the QCC. These signals consist of a positive clock signal and a negative clock signal, which are processed through the positive and negative lines (e.g., 310 and 330 in circuit 300). These lines include inverters that introduce controlled delays, helping synchronize the clock signals. Crossover section 320 of the clock correction circuit provides real-time corrections to timing discrepancies between the positive and negative clock signals. For example, phase misalignments or duty cycle distortions detected between the clock signals are corrected through the selective activation of crossover inverters in the circuit. In embodiment, controller 340 continuously monitors the outputs of the positive and negative lines (Outp and Outn) to ensure the clock signals are synchronized. If timing errors are detected, the controller dynamically adjusts the crossover inverters to maintain synchronization. The corrected clock signals are then fed into the 4:1 MUX.

These corrected clock signals control the timing of the multiplexing operation, ensuring that each input data stream from the P2S converter is accurately selected and combined into the output serial data stream. The high precision and low jitter of these clock signals, achieved through the corrections applied by circuit 300, are important for the correct operation of the MUX, as timing errors in the clock signals could lead to incorrect data being transmitted or received, resulting in data corruption or loss. In high-speed communication systems, such as those employing a 4:1 MUX to combine multiple data streams, the integrity of the clock signals is important. Clock correction circuit 401 ensures that these clock signals are not only synchronized but also free from distortions that could impact the timing of data transitions.

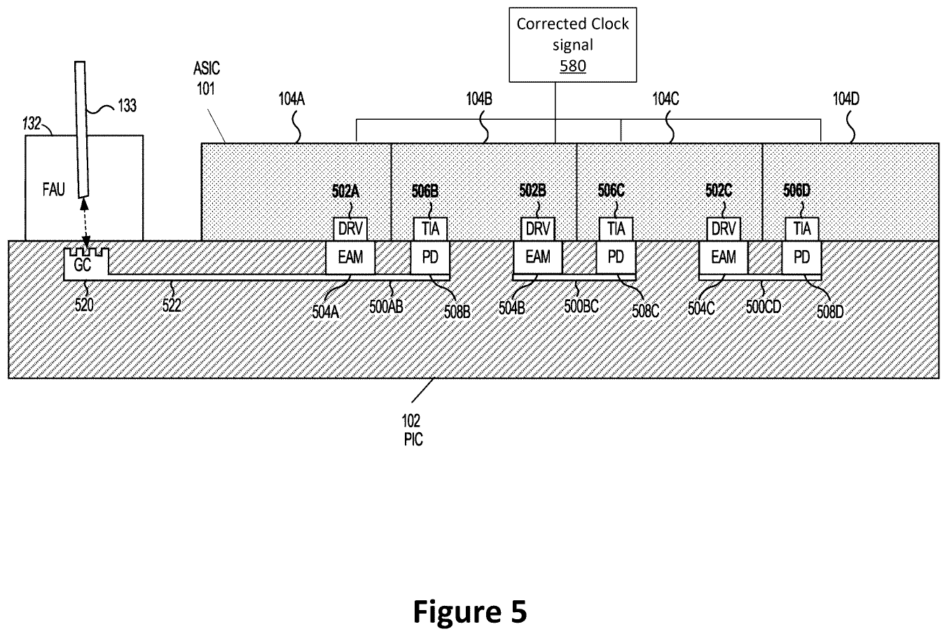

FIG. 5 is a simplified diagram illustrating an electro-photonic network with clock signal correction according to embodiments of the present invention. This diagram is merely an example, which should not unduly limit the scope of the claims. One of ordinary skill in the art would recognize many variations, alternatives, and modifications. As an example, FIG. 5 shows the configuration of an application-specific integrated circuit (ASIC) 101 situated above a photonic integrated circuit (PIC) 102. Various tiles (104A, 104B, 104C, and 104D) within the ASIC are shown, along with the electro-optic (EO) and optoelectronic (OE) interface components that facilitate communication between these tiles through optical links in the PIC. The optical signals in the PIC are coupled to external systems via an optical fiber 133 connected to the fiber array unit (FAU) 132. For example, the light is coupled into the PIC using a grating coupler 520, which directs the light to the EAMs (504A, 504B, 504C) via waveguides.

Corrected clock signal circuit 580 is coupled to tiles 104A-D to provide clock signals driving the optical modulation and detection processes are synchronized and free from distortions. In various implementations, corrected clock signals are generated using circuits similar to circuit 300 (as described in FIG. 3) or circuit 100 (as described in FIG. 1), which adjust the timing of the clock signals to correct any phase misalignments or jitter. The clock correction circuit ensures that the modulator drivers (502A, 502B, 502C) operate with precise timing, which is crucial for maintaining the integrity of the optical signals transmitted through the PIC.

In an implementation, the corrected clock signal is generated from a clock source located on a separate chip (not shown in FIG. 5) and is distributed to the various blocks 104A-D. The corrected clock signals ensure that the timing of the optical modulation and detection processes in each block is synchronized and free from distortions, such as phase misalignments or jitter. For example, tiles 104B and 104C both receive the corrected clock signals to drive their respective modulator drivers (e.g., 502B, 502C) and transimpedance amplifiers (506C), ensuring precise timing for data modulation and reception. The corrected clock signals are also provided to tiles 104A and 104D, allowing for consistent and synchronized operation across all blocks.

In an embodiment, the corrected clock signal is distributed from the separate clock source to each block (104A-D) in the ASIC. It feeds into both the modulator drivers (e.g., 502A, 502B, 502C) and the receiver circuits (e.g., 506B, 506C, 506D) in each tile. These corrected clock signals ensure that the drivers and transimpedance amplifiers (TIAs) operate with precise timing, which is crucial for maintaining the integrity of the optical signals transmitted and received through the PIC. For example, in tile 104B, modulator driver 502B uses the corrected clock signal to generate modulated optical signals that are transmitted via optical waveguide 500BC to receiver 506C in tile 104C. The corrected clock signals ensure that the timing of the optical modulation in 502B and the reception in 506C is perfectly synchronized, avoiding data errors due to timing mismatches.

The modulator drivers (e.g., 502A, 502B, 502C) are electronic components situated within the ASIC 101 in tiles 104A, 104B, and 104C. These drivers are responsible for generating the electrical signals that modulate light within the EAMs (e.g., 504A, 504B, 504C), which are configured directly beneath the drivers in the PIC 102. For example, the EAMs convert the electrical signals from the modulator drivers into modulated optical signals that can be transmitted through the optical waveguides (e.g., 500AB, 500BC, 500CD) embedded in the PIC. As shown, the waveguides form the optical links between the tiles, enabling high-speed intra-chip communication.

In FIG. 5, TIAs (e.g., 506B, 506C, 506D) transimpedance amplifiers for converting small current signals generated by the photodetectors (e.g., PDs 508B, 508C, 508D) into amplified voltage signals that can be further processed by the system. For example, the photodetectors first convert incoming optical signals into electrical current. For example, the PDs are located in the PIC directly beneath the TIAs, ensuring that the distance between the optical and electronic components is minimal.

As an example, circuit 300 (as described in FIG. 3) and circuit 400 (as described in FIG. 4) are implemented within the modulator driver 502A and the EAM 504A to ensure that the clock signals driving the modulation process are synchronized and free from distortions. In various embodiments, circuit 300 is integrated into the modulator driver 502A to provide timing corrections to the clock signals that modulate the EAM 504A. The positive and negative clock signals processed through the positive line 310 and negative line 330 of circuit 300 help ensure that the EAM is modulated at the correct times, thereby maintaining the integrity of the optical signals transmitted through the waveguides. For example, crossover section 320 in circuit 300 adjusts the timing of the clock signals to correct any phase mismatches or timing errors, ensuring that the modulated optical signals remain synchronized with the overall system timing.

For example, circuit 400 in FIG. 4 is implemented in the modulation process within 502A and 504A to combine multiple data streams and modulate them onto the optical carrier generated by the EAM. The clock signals driving the 4:1 MUX are corrected by circuit 300 before being fed into the MUX. This ensures that the multiplexed data streams are accurately aligned with the modulated optical signal, preventing any data errors that could arise from timing mismatches.

It is to be appreciated that the close alignment between the electronic components (e.g., modulator drivers, TIAs) in the ASIC 101 and the photonic components (e.g., EAMs, PDs) in the PIC 102 is important for minimizing the distance over which electrical and optical signals must travel. This minimizes latency and reduces the power required for signal conversion. Additionally, the heat generated by the electronic components in the ASIC can help maintain the EAMs and PDs in the PIC at optimal operating temperatures, enhancing the overall thermal stability and performance of the system.

While the above is a full description of the specific embodiments, various modifications, alternative constructions and equivalents may be used. Therefore, the above description and illustrations should not be taken as limiting the scope of the present invention which is defined by the appended claims.

What is claimed is:

1. A circuit comprising:
a differential input comprising a positive input and a negative input, the different input being configured to receive different clock signals, the differential clock signals comprising a positive clock signal and a negative clock signal;
a differential output comprising a positive output and a negative output;
a positive line coupled to the positive input and the positive output, the positive line comprising a first positive inverter and a second positive inverter;
a negative line coupled to the negative input and the negative output, the negative line comprising a first negative inverter and a second negative inverter; and
a first crossover inverter directed coupled to the positive line and the second negative inverter at a first node, the first crossover inverter being characterized by a first delay, the first crossover inverter being configured to provide a positive correction signal based on the positive clock signal with the first delay to the first node.

2. The circuit of claim 1, further comprising:
a third positive inverter directly coupled to the first positive inverter and the second positive inverter;
a third negative inverter directly coupled to the first negative inverter and the second negative inverter; and
a second crossover inverter coupled to the negative input and a node between the second positive inverter and the third positive inverter.

3. The circuit of claim 1, further comprising a controller coupled to the negative output, the controller being configured to provide a control signal disengage the first crossover inverter based at least on the negative output.

4. The circuit of claim 3, further comprising a switch configured to disengage the first crossover inverter in response to the control signal.

5. The circuit of claim 3, further comprising a matrix bus for coupling crossover inverters to the positive line and the negative line.

6. The circuit of claim 3, wherein the controller is configured on a feedback path.

7. The circuit of claim 1, wherein the positive correction signal comprises the first delay and a second delay the first positive inverter.

8. The circuit of claim 1, further comprising a second crossover inverter directed coupled to the negative line and the second positive inverter at a second node, the second crossover inverter being characterized by a second delay, the first crossover inverter being configured to provide a positive negative signal based on the negative clock signal with the second delay to the first node.

9. A clock compensation device, comprising
a differential input comprising a positive input and a negative input, the differential input being configured to receive differential clock signals, the differential clock signals comprising a positive clock signal and a negative clock signal;
a differential output comprising a positive output and a negative output;
a positive line coupled to the positive input and the positive output, the positive line comprising a first positive inverter and a second positive inverter;
a negative line coupled to the negative input and the negative output, the negative line comprising a first negative inverter and a second negative inverter;
a controller coupled to the differential output, the controller being configured to provide a control signal based at least on the differential output; and
a crossover section coupled to the controller, the crossover section comprising a first crossover inverter, the crossover section being configured to provide a first correction signal by connecting a first node on the positive line to a second node on the negative line via the first crossover inverter.

10. The device of claim 9, further comprising a feedback path comprising the differential output and the controller, the feedback path being configured to provide feedback signals indicative of a designed adjustment for the positive output and the negative output.

11. The device of claim 9, wherein the controller is configured to adjust operation of the crossover section based on a difference between the positive output and the negative output.

12. The device of claim 9, wherein the crossover section further comprising a second crossover inverter, the crossover section being configured to provide a first correction signal by connecting a third node on the negative line to a fourth node on the positive line via the second crossover inverter.

13. The device of claim 9, wherein the crossover section further a matrix bus and a plurality of switches for selecting the first node and the second for generating the first correction signal.

14. The device of claim 9, wherein the controller is configured to determine a connection of the first crossover inverter based on a desired adjustment and a delay associated with the first crossover inverter.

15. A driver circuit comprising:
a differential input comprising a positive input and a negative input, the differential input being configured to receive differential clock signals, the differential clock signals comprising a positive clock signal and a negative clock signal;
a differential output comprising a positive output and a negative output;
a positive line coupled to the positive input and the positive output, the positive line comprising a first positive inverter and a second positive inverter;
a negative line coupled to the negative input and the negative output, the negative line comprising a first negative inverter and a second negative inverter;
a first crossover inverter directly coupled to the positive line and the second negative inverter at a first node, the first crossover inverter being characterized by a first delay, the first crossover inverter being configured to provide a positive correction signal based on the positive clock signal with the first delay to the first node; and
a multiplexer (MUX) configured to receive the corrected differential clock signals from the differential output, the MUX being configured to select one of multiple input data signals based on the timing of the corrected differential clock signals.

16. The driver circuit of claim 15, further comprising a clock generation circuit coupled to the differential input, the clock generation circuit being configured to generate the differential clock signals with a frequency and phase for the MUX.

17. The driver circuit of claim 15, wherein the clock generation circuit comprises an injection-locked oscillator (ILO) configured to generate a reference clock signal, the reference clock signal being provided to the differential input as the differential clock signals.

18. The driver circuit of claim 15, wherein the MUX comprises a 4:1 multiplexer, the MUX being configured to combine four input data streams into a single output data stream based on the timing of the corrected differential clock signals.

19. The driver circuit of claim 15, further comprising a parallel-to-serial (P2S) converter coupled to the MUX.

20. The driver circuit of claim 15, further comprising a controller coupled to the negative output, the controller being configured to provide a control signal disengage the first crossover inverter based at least on the negative output.
